(19) United States
(12) Patent Application Publication
(10) Pub. No.: US 2007/0267229 A1
(43) Pub. Date: Nov. 22, 2007

(54) Method for Recognizing the Path of a Tip a Body on a Medium

(75) Inventor: Yanis Caritu, Grenoble (FR)

Correspondence Address: OLIFF & BERRIDGE, PLC, P.O. BOX 19928, ALEXANDRIA, VA, 22320, US

(73) Assignee: COMMISSARIAT A L'ENERGIE ATOMIQUE, PARIS (FR)

(21) Appl. No.: 10/585,924

(22) PCT Filed: Feb. 1, 2005
(86) PCT No.: PCT/FR05/00212

§ 371 Date: Jul. 13, 2006

(30) Foreign Application Priority Data
Feb. 12, 2004 (FR) 04 01402

(51) Int. Cl. G06F 3/033

(52) U.S. Cl. 178/19.01

(57) ABSTRACT

An angle sensor enables the angle of orientation of a body to be determined. A force sensor measures the reaction for of the tip of the body in contact with the medium in almost continuous manner. The orientation of the reaction force with respect to the medium plane is determined from measurement data from said sensors. A vector tangential to the path is determined by projection of the reaction force in the medium plane. The path can be determined by mathematical integration of the tangential vector or by double mathematical integration of the tangential acceleration which can be determined for example by the scalar product of a tangential unitary vector obtained by normalization of the tangential vector and of data representative of the acceleration supplied by the accelerometer.

### BACKGROUND OF THE INVENTION

The invention relates to a method for recognizing the path of a tip of a body on a medium, comprising determination of an angle of orientation of the body by processing measurement data supplied to a processing unit by at least one angle sensor arranged in the body, the body comprising a force sensor measuring the reaction force of the tip of the body in contact with the medium, the force sensor supplying data representative of the reaction force in almost continuous manner to the processing unit, the processing unit determining the orientation of the reaction force with respect to the plane of the medium from the measurement data from the angle sensor and from the force sensor.

### STATE OF THE ART

At present, digital pens on the market require a prepared medium or a reference source enabling the movements of the tip of the pen to be recognized, for example digitizing tables, special screens, ultrasonic sources, electromagnetic sources or special papers, which complicates use of the pen.

A trace written on a medium is transcribed onto a computer screen by means of the pen. Typically, a digital pen enables written symbols, for example characters and signatures, to be recognized.

Generally, a digital pen comprises several sensors, for example inertia sensors of the accelerometer type, and angle sensors for example of the magnetometer or gyrometer type, and possibly a detector of the reaction force of a pen tip in contact with the medium, enabling it to be recognized whether the pen is in contact with a writing medium or not. The acceleration of the pen tip on the writing medium is obtained by processing measurement data supplied by the sensors. A double mathematical integration of a quantity that is a function of the acceleration then enables an approximate determination of the path of the pen tip on the writing medium to be made. The data processing operations are performed by a processing unit located for example in the pen.

The document U.S. Pat. No. 5,548,092 describes a method for visualizing written information on a medium by measuring the forces applied to the tip of a pen. The pen comprises a sensor to measure the force of the pen tip on the medium. Additional sensors enable the movements and orientation of the pen in relation to the medium to be measured, even if the pen is not in contact with the medium. A force having the direction of the longitudinal axis of the pen comprises components oriented along two orthogonal axes arranged in a writing plane. The forces measured in the reference frame of the pen are transformed into an absolute reference frame. The document defines an angle of inclination of the pen with respect to the gravitational axis and an azimuth angle with respect to one of said orthogonal axes. A friction force is represented by the sum of a static component and of a dynamic component dependent on the speed. The static component is subtracted from the measured force to define a net force which is by definition zero when the measured force is lower than the product of the longitudinal force and of the static friction coefficient. Then the time derivative of the quantity of movement is expressed as a function of the net force and of the dynamic friction force. The differential equation is then solved to determine the speed and the position. Calculation of the position and speed components of the pen tip in the plane of the medium is performed, by integration, taking corresponding components of the net force into account.

Due to the intrinsic structure of the pen described in the document U.S. Pat. No. 5,548,092, the azimuth angle is assumed to be constant and the pen comprises an edge preventing the user from turning the pen when writing. This means that the pen is in a fixed position in the user's hand. This hypothesis is very restrictive with respect to reality.

The document WO99/67652 describes a pen comprising force, acceleration and contact sensors integrated in a measuring device comprising an inertial mass coupled to the pen tip. In addition, the pen comprises a device for measuring the angles of inclination of the pen. The measuring devices transmit measurement data to a control unit. The measurement data are processed to determine the forces and accelerations applied to the pen. A method of using the pen comprises an initialization phase, a measuring phase and a data processing phase. The data enable it to be determined whether the pen is in contact with a writing medium or not. If a contact is detected, the data are interpreted as forces. If there is no contact, the data are interpreted as accelerations.

### OBJECT OF THE INVENTION

The object of the invention is to simplify recognition of the path of a tip of a body on a medium and to increase the path recognition precision, in particular for recognition of the path of a pen tip on a writing medium, while simplifying use of the pen.

According to the invention, this object is achieved by the appended claims, and in particular by the fact that the processing unit determines a vector tangential to the path by projection of the reaction force in the plane of the medium, the path being determined by at least one mathematical integration of a quantity that is a function of the vector tangential to the path.

### BRIEF DESCRIPTION OF THE DRAWINGS

Other advantages and features will become more clearly apparent from the following description of particular embodiments of the invention given as non-restrictive examples only and represented in the accompanying claims, in which:

FIG. 1 represents a digital pen according to the prior art.

FIGS. 2 et 3 illustrate two particular embodiments of a recognition method according to the invention, in the form of functional block diagrams.

### DESCRIPTION OF PARTICULAR EMBODIMENTS

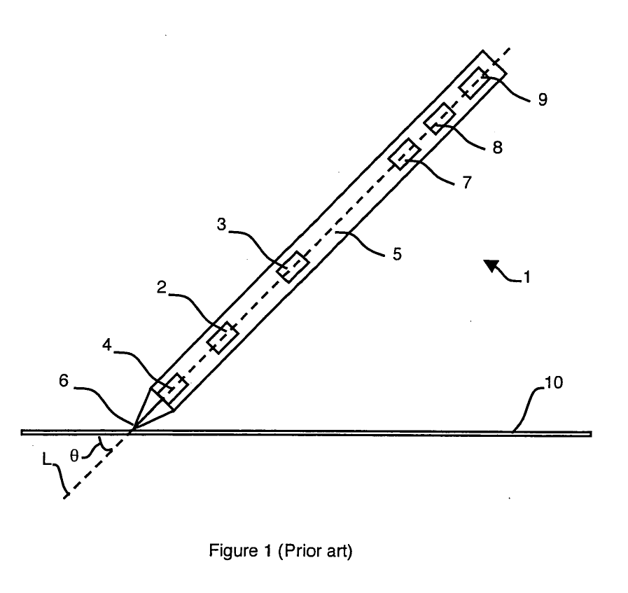

In FIG. 1, a pen 1 comprises an accelerometer 2, an angle sensor 3 and a force sensor 4 arranged in the case 5 of the pen, in a front part of the pen 1. The force sensor 4 is mechanically connected to the tip 6 of the pen and the accelerometer 2 is advantageously located near the tip 6. The angle sensor 3 can be formed by a set of three gyrometers or preferably by a set of three magnetometers. Electronic circuits, in particular an analog-to-digital converter 7, a processing unit 8 and a transmitter 9 or transceiver, are also arranged in a rear part of the pen 1. Data processing can be performed by the processing unit 8 or by a remote station receiving the data by means of the transmitter 9. The pen 1 enables writing to be performed on any medium 10 without requiring additional equipment. In FIG. 1, the angle θ of the longitudinal axis L of the pen 1, i.e. the angle of inclination of the pen 1, is defined with respect to the plane of the medium 10. The medium is preferably flat. A surface with small deformations can however also be used.

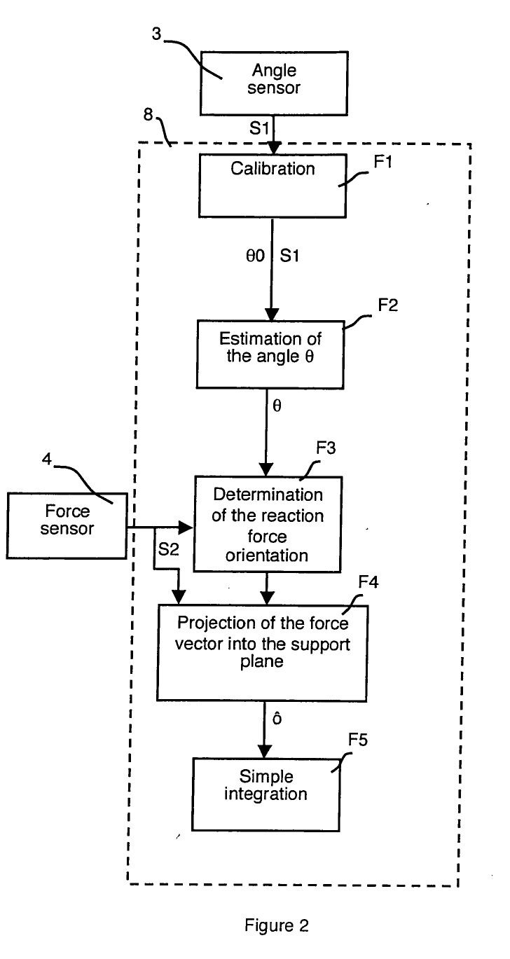

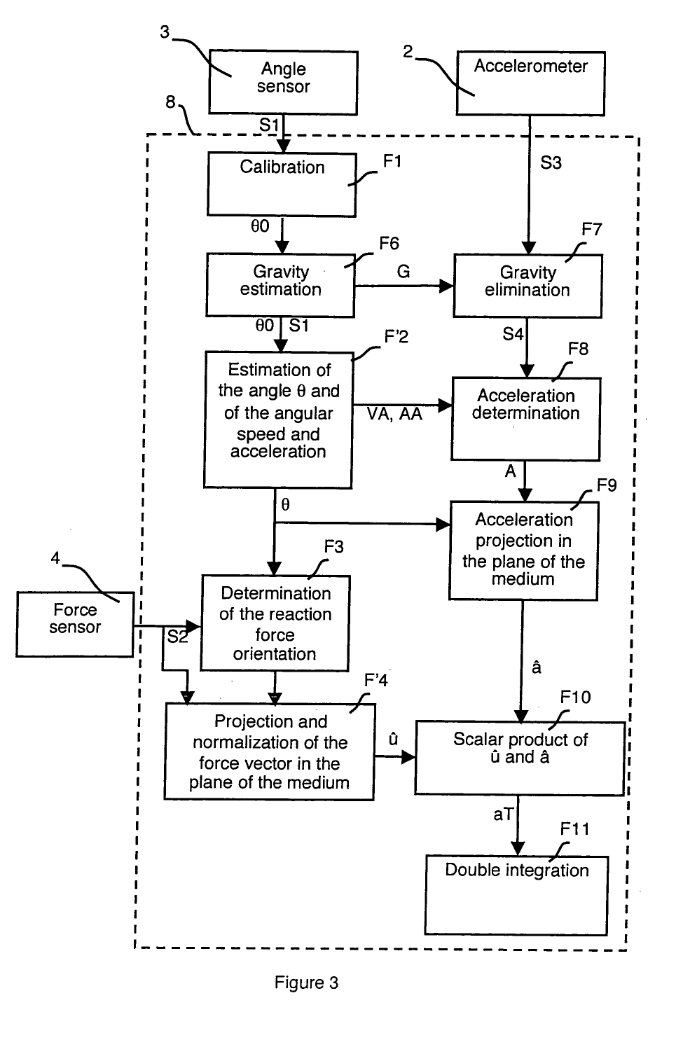

In a simplified first embodiment illustrated in FIG. 2, the path of the tip 6 of the pen 1 is determined from data S1 and S2 supplied to the processing unit 8 respectively by the angle sensor 3 and the force sensor 4. The recognition method can comprise a calibration step F1 of the orientation θ0 of the medium 10, before beginning writing. For example, the pen is placed at a predetermined angle with respect to an axis perpendicular to the medium, preferably perpendicularly to the medium 10, during the calibration step F1 and the angle sensor 3 thus supplies the angle of orientation θ0 of the medium 10. If the orientation of the medium 10 is subsequently modified, the calibration has to be updated. If the medium 10 comprises several zones having different orientations, the calibration can be updated each time the tip 6 of the pen 1 changes zone.

Estimation of the angle θ of the pen 1 with respect to the angle of orientation θ0 of the medium 10 is then performed in known manner, in a step F2, from the measurement data S1 of the angle sensor 3.

The data S2 are supplied to the processing unit 8 by the force sensor 4 in almost continuous manner. They are representative of the reaction force of the tip 6 of the pen 1 in contact with the medium 10. The measurement is three-dimensional and proportional to the reaction force. Information on the direction and amplitude of the reaction force and not a simple contact detection is thus obtained. The reaction force is measured in the reference frame of the pen 1. The orientation of the reaction force with respect to the plane of the medium 10 is determined (F3) from the measurement data S1 of the angle sensor 3, more particularly from the angle θ, and from the measurement data S2 of the force sensor 4. The reaction force in the reference frame of the medium 10 is thus obtained. Then the reaction force is projected (F4) into the plane of the medium 10, which enables the component perpendicular to the medium 10 corresponding to the pressing pressure applied by user to be eliminated, which is not without importance for determining the path of the tip 6 of the pen 1. The component in the plane of the medium 10, the result of the projection, is due to the friction force of the tip 6 of the pen 1 on the medium 10. This friction force is anti-parallel to the movement of the tip 6 of the pen 1 in the plane of the medium 10, tangential to the path of the tip 6 of the pen 1 on the medium 10. A vector ô is thus obtained tangential to the path of the tip 6 of the pen 1, which vector is representative of the direction of the speed of the tip 6 in the plane of the medium.

In a step F5 comprising a simple mathematical integration of the tangential vector ô, the processing unit 8 determines the path of the tip 6 of the pen on the medium 10.

It should be noted that according to the document U.S. Pat. No. 5,548,092, the net force, which is used for calculating the position and speed of the tip of the pen, is equal to the sum of a quantity proportional to the speed (tangential to the path) and of a quantity proportional to the acceleration (not necessarily tangential). The net force used in the document U.S. Pat. No. 5,548,092 does not therefore correspond to a vector tangential to the path, in so far as it comprises an acceleration vector, which is not necessarily tangential to the path.

In a second embodiment, illustrated in FIG. 3, the path of the tip 6 of the pen 1 is determined from data S1, S2 and S3 supplied to the processing unit 8 respectively by the angle sensor 3 and force sensor 4 and the accelerometer 2. Processing of the data S3 from the accelerometer enables a better precision of determination of the path to be obtained.

The accelerometer 2 being influenced by gravitation, it is desirable to eliminate the contribution of gravity to the measurement. The measurement data supplied by the angle sensor 3 enable the contribution G of gravity to the measurement of the accelerometer 2 to be estimated (F6) in known manner, and said contribution G to then be eliminated (F7) from the data S3 supplied by the accelerometer 2 so as to obtain reduced data S4 which are a function of the acceleration of the movement only.

The reduced data S4 thus represent the acceleration of the movement at the location of the accelerometer 2, which is in principle different from the acceleration A of the tip 6 of the pen 1. To determine the acceleration A of the tip 6 of the pen 1 in a step F8, estimation of the angle θ of the pen 1 with respect to the angle of orientation θ0 of the medium 10 is performed in known manner in a step F′2 from the measurement data S1 of the angle sensor 3, and also from the angular speed VA and angular acceleration AA of the pen 1, respectively by means of the first and second derivative of the angle θ with respect to time. To perform the step F8, the laws of composition of movements of conventional mechanics are used, taking the vector linking the location of the accelerometer 2 and the tip 6 of the pen 1 into account.

The acceleration A of the tip 6 of the pen 1 can then be projected (step F9) into the plane of the medium 10 so as to obtain the acceleration a of the tip 6 of the pen 1 on the medium 10. The projection in the plane of the medium 10 can therefore be calculated from the data S1 and S3, respectively supplied by the angle sensor 3 and the accelerometer 2 and enabling the angle of orientation θ0 of the medium 10, the angle θ of the pen 1 with respect to the angle of orientation θ0, and the acceleration A of the tip 6 of the pen 1 to be determined.

In the step F′4, as in the step F4, the vector ô tangential to the path of the tip 6 of the pen 1 is obtained, and in addition, by normalization of the tangential vector ô, a unitary vector û tangential to the path of the tip 6 of the pen 1 is obtained.

In a step F10, the processing unit 8 determines the scalar product of the unitary vector û and of the acceleration â of the tip 6 of the pen 1 on the medium 10, which enables the component aT of the acceleration tangential to the path to be determined. The path is then determined by double mathematical integration F11 of the tangential component aT of the acceleration.

The component aT of the acceleration tangential to the path may be determined by the scalar product of the unitary vector û and of the acceleration A of the tip 6 of the pen 1, without making the projection F9 of the acceleration A of the tip 6 of the pen 1 in the plane of the medium 10. However, the projection step F9 enables information to be drawn on the curvature of the path by means of the component of the acceleration perpendicular to the path.

Combined use of the angle sensor 3 and force sensor 4 enables the contributions of forces that are not connected to the path, for example the weight or pressure of the pen 1 perpendicularly to the medium, to be correctly eliminated from the measurement of the acceleration aT.

Using the method according to the invention in particular enables signature recording and recognition to be efficiently performed. For example, several signatures are recorded for each person using the pen 1 to determine a mean signal for each person. When the pen 1 is operating in a signature recognition mode, processing, typically consisting in minimizing the quadratic distance between a standardized signature measurement and the previously recorded standardized mean signals, enables the signature to be recognized with certainty.

The invention is not limited to recognition methods of a pen tip path. The pen 1 can be replaced by any body comprising for example any actuator, for example an etching tip, the path whereof is determined during actuation.

The method also enables the path of a measuring device, for example a feeler, comprising any sensor, for example a thermal, electric or photometric sensor, to be determined. A physical measurement by means of a sensor associated with the body 1 is thus made at the same time as path recognition is performed, which enables a mapping of the measured physical quantity to be established by correlating the measurement with the determined path.

1-11. (canceled)

12. Method for recognizing the path of a tip of a body on a medium, comprising determination of an angle of orientation of the body by processing measurement data supplied to a processing unit by at least one angle sensor arranged in the body, the body comprising a force sensor measuring the reaction force of the tip of the body in contact with the medium, the force sensor supplying data representative of the reaction force in almost continuous manner to the processing unit, the processing unit determining the orientation of the reaction force with respect to the plane of the medium from the measurement data from the angle sensor and from the force sensor, method wherein the processing unit determines a vector tangential to the path by projection of the reaction force in the plane of the medium, the path being determined by at least one mathematical integration of a quantity that is a function of the vector tangential to the path.

13. Method according to claim 12, comprising mathematical integration of the tangential vector.

14. Method according to claim 12, wherein the medium is flat.

15. Method according to claim 12, comprising a calibration and orientation step of the medium.

16. Method according to claim 15, wherein the body is placed at a predetermined angle with respect to an axis perpendicular to the medium during the calibration step.

17. Method according to claim 16, wherein the body is placed perpendicularly to the medium during the calibration step.

18. Method according to claim 12, comprising determination of the acceleration of the tip by processing of measurement data supplied to the processing unit by the angle sensor and by at least one accelerometer located in the body, the processing unit determining a unitary vector tangential to the path by normalization of the vector tangential to the path and determining the scalar product of data representative of the acceleration and of the unitary vector so as to obtain said quantity representative of the tangential acceleration of the tip of the body, the path being determined by double mathematical integration of said quantity.

19. Method according to claim 18, wherein the processing unit determines the projection of the acceleration in the plane of the medium according to the data supplied by the accelerometer and the angle sensor, so as to supply said data representative of the acceleration.

20. Method according to claim 18, comprising an estimation of the contribution of gravity to the measurement data supplied by the accelerometer and elimination of said contribution from the data supplied by the accelerometer.

21. Method according to claim 12, wherein the body comprises a sensor designed to supply the measurement of a physical quantity so as to enable mapping of said physical quantity according to the measured path.

22. Method according to claim 12, wherein the body comprises an actuator.
